(19) United States
(12) Patent Application Publication
(10) Pub. No.: US 2005/0254613 A1
(43) Pub. Date: Nov. 17, 2005

(54) Fusion energy system and plasma propulsion aircraft to produce electricity from a controlled nuclear fusion reaction

(76) Inventor: Gary Richard Gochnour, Seattle, WA (US)

Correspondence Address: Gary Richard Gochnour, 1415 E. Olive St., Apt. #303, Seattle, WA, 98122, US

(21) Appl. No.: 10/841,702

(22) Filed: May 6, 2004

(51) Int. Cl. G21B 1/00

(52) U.S. Cl. 376/100

(57) ABSTRACT

The invention relates to a plasma based aircraft, and in particular, to a plasma based aircraft maintained in a flight mode by an uplifting Larmor gyro orbiting particle field, and a capacitor based electric grid system. The second part of this invention relates to the process portion of the invention pertaining to the use of three of the said aircraft, and with definite methods and procedures, to attain a nuclear fusion reaction, without significant radiation produced and without cooling required. The fusion process also contains a method to successfully slow and capture as electricity, the majority of the energy produced. Fuel for the plasma based aircraft is H0− ions and H+ ions, fuel for the fusion process is the B-11 isotope and Regular Hydrogen. These are the only fuels that will be required.

This non-provisional patent application claims the benefit of provisional patent application with Ser. No. 60/468,598, filed May 6, 2003.

### FIELD OF INVENTION

This invention relates to a new type multi-functional electromagnetic, plasma-based aircraft, capable of operation in the atmosphere as an aircraft, under water as a submersible craft, in outer space as a space craft, or as a boring device, or a lifting device. Three of the aircraft described, utilized in an aircraft mode, being craft of variable sizes, utilized together, are able to be used in a process to obtain a nuclear fusion reaction to obtain electricity. The fusion process will be explained in detail as a process portion of this utility patent.

### BACKGROUND OF THE INVENTION

The impending depletion of the world's fossil fuel resources will require new energy systems based on abundant, available fuels. This invention utilizes only the H0− ions and H+ ions from water for the fuel for the utility portion of this patent. For the process portion of this patent, the boron-11 isotope and regular hydrogen, H-1, are used. Boron is found abundantly in seawater, and is also found in borax. There are over 200 million tons of borax in California, and over 500 million tons in Turkey. It is found abundantly in other countries as well.

This invention is a new breakthrough technology. It should be in the mainstream of World technology.

### SUMMARY OF THE INVENTION

In the present invention, the aircraft operates within a plasma invironment of energetic charged particles. The aircraft operations will be performed in a hyperdynamic state. The fusion portion of this utility patent, utilizes the aircraft within the fusion process.

In the aircraft of the present invention, ions will be produced within the aircraft.

In the present invention, ions, after being electrolyzed out of solution, will be placed into Larmor gyro orbiting particle fields around the aircraft.

In the present invention, the orbiting particle field, possessing a rotational direction for upward movement, will lift the aircraft off the ground, or other surface.

In the present invention, fuel utilized will be H0− ions and H+ ions from electrolysis of water. Fuel for the fusion system will be from electrolysis of seawater or from borax.

In the present invention, navigation will be by means of utilizing ailerons possessing a charge within particle field, the dominate charge of the orbit fields used being generally positive, and by use of rotating plasma vortices placed in direction of travel by ailerons.

In the present invention, the aircraft can be used as an aircraft, a space or submersible craft, boring or lifting device.

### BRIEF DESCRIPTION OF THE DRAWING

FIG. 1 is a side view of the aircraft showing a lenticular configuration of the aircraft from the side, and a side view of the annular bladed ring assembly encircling the aircraft, and extending out from the sides of the aircraft.

FIG. 2 is a top plan view of the aircraft showing the circular configuration of the aircraft, and a top plan view of the annular bladed ring assembly.

FIG. 3 is a bottom plan view showing the circular configuration of the aircraft, and a bottom plan view of the annular bladded ring assembly.

FIG. 4 is a top plan view of a capacitor, electric grid plate attached to the top of the top planar surface of the bottom half of aircraft hull, and a top plan view of the annular bladed ring assembly.

FIG. 5 is a cross section side view of the aircraft showing the ion acceleration system and the central shaft containing the inductance coil. Also shown is a cross section side view of the annular bladed ring assembly.

FIG. 6a is a diagram showing the angular relationship of the aircraft magnetic and electric fields.

FIG. 6b is a side view of a small portion of the bottom half of aircraft hull showing a view of a round opening into hull to insert the axel of an aileron blade, and also shown is a view of an opening to extract and replace worn or burnt ailerons.

FIG. 6c is a side view of the aircraft using particle impact on ailerons to determine banking direction.

FIG. 6d is a side view of the aircraft using particle impact on ailerons to determine banking direction. Banking is in opposite direction to aircraft in FIG. 6c.

FIG. 6e is a side view of the aircraft. The charged particles are impacting the ailerons on bottom surface. The aircraft will rise in altitude.

FIG. 6f is a side view of the aircraft using particle impact on ailerons to determine altitude direction. Particles will impact top surfaces of ailerons. The aircraft will descend.

FIG. 7a is a side view of an aircraft within rotating vortices. Ailerons have determined the position for direction of travel. Increase in rotation of vortice will propel the aircraft diagonal to Earth.

FIG. 7b is a side view of an aircraft within rotating vortices being propelled horizontal with Earth.

FIG. 7c is a side view of an aircraft within rotating vortices. Increase in rotation of vortices will propel the aircraft vertical to Earth.

FIG. 8a is top view of extricated capacitor system from aircraft, combined negative charge is moving aircraft away from lesser positive charge in direction of arrow,

FIG. 8b is a top view of extricated capacitor system from aircraft. Combined negative charge, greater than positive charge, is moving craft away from positive charge in direction of arrow, to the East.

FIG. 9 is a top view the aircraft plasma propulstion system with capacitor, electric grid system and radial plasma gun.

FIG. 10 is a side view of aircraft in electric force propulsion mode interacting with Earth's magnetic field.

FIG. 11a is a perspective view of the top surface of aircraft showing exit electrodes for fusion fuels and propulsion fuels.

FIG. 11b is a side view of aircraft showing raised pyramid and ion acceleration system, and ball electrode.

FIG. 12a is a side view of three aircraft positioned to effect a nuclear fusion reaction.

FIG. 12b is a side view of the fusion spherical plasma and two adjacent spherical plasmas showing directions of plasma rotation.

FIG. 12c is a top view of the induced Larmor orbiting particle field and a top view of the spherical plasma for ignition.

FIG. 13 is a side view of three aircraft positioned to effect a nuclear fusion reaction close to ignition of spherical plasma.

FIG. 14 is the spherical plasma between the three aircraft in the process of ignition by land based laser and neautral beams.

FIG. 15 shows end phase of fusion process, storing electricity.

### DESCRIPTION OF THE PREFERRED EMBODIMENT

The operation of the aircraft as a system and device will be described first. The aircraft being the invention. This will be followed by a description of the preferred embodiment of the aircraft. Next, a process portion of this utility patent will follow. The process portion relates to a fusion energy process utilizing the aircraft. The operation of the fusion energy process will be described first in the fusion energy process part of this patent, followed by a description of the preferred embodiment for this process.

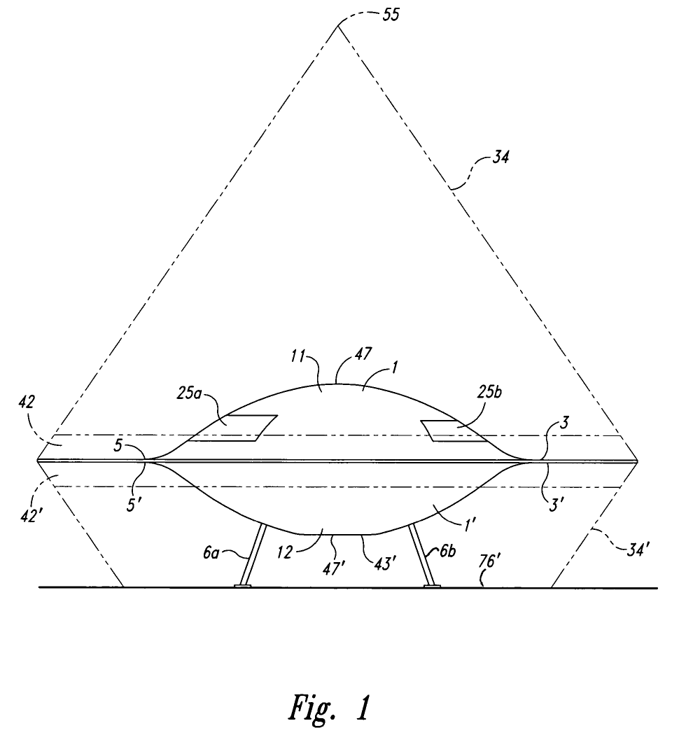

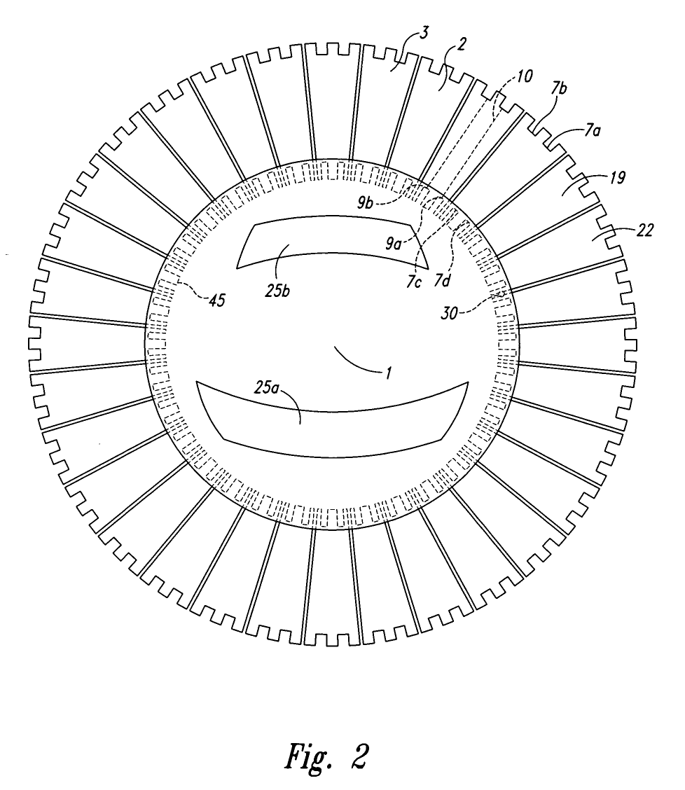

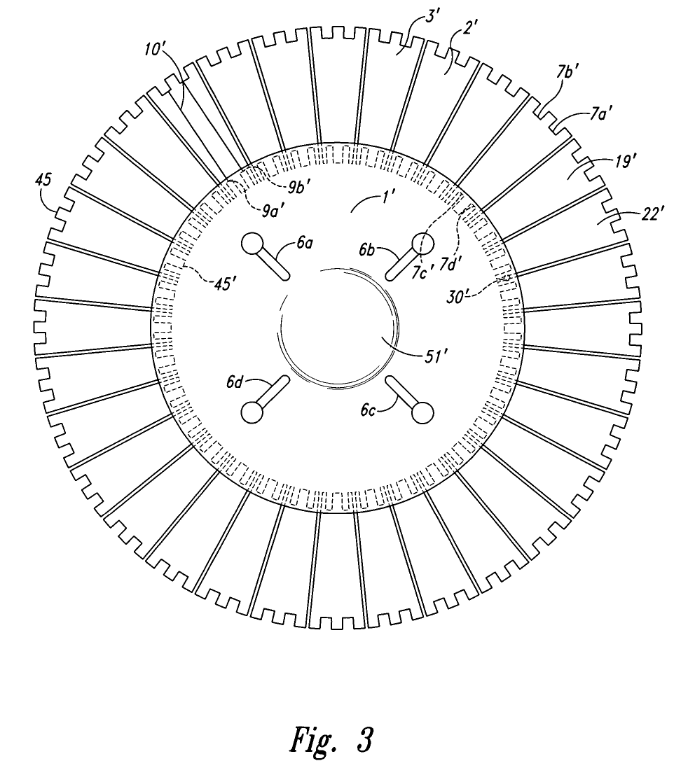

Operation of the aircraft. Referring to FIGS. 1, 2 and 3, a Multi-functional Aircraft (MFA), also called “aircraft”, or “craft”, or “device”, according to the present invention is shown. When viewed from the side, the aircraft has a lenticular shape as shown in FIG. 1. When viewed from the top, the aircraft has a circular shape as shown in FIG. 2. When viewed from the bottom, the aircraft has a circular shape as shown in FIG. 3. The aircraft is comprised of a top half body hull 1, FIGS. 1 and 2, and a bottom half body hull 1′, FIGS. 1 and 3. Referring to FIGS. 1, 2, 3 and 4, a multi-bladed annular ring assembly 3, 3′, also called “bladed ring assembly’, or called, ailerons, or “annular ring”, or “ring assembly”, or “ring”, is located between the bottom surface of the top half of hull 1, and the top surface of the bottom half of hull 1′.

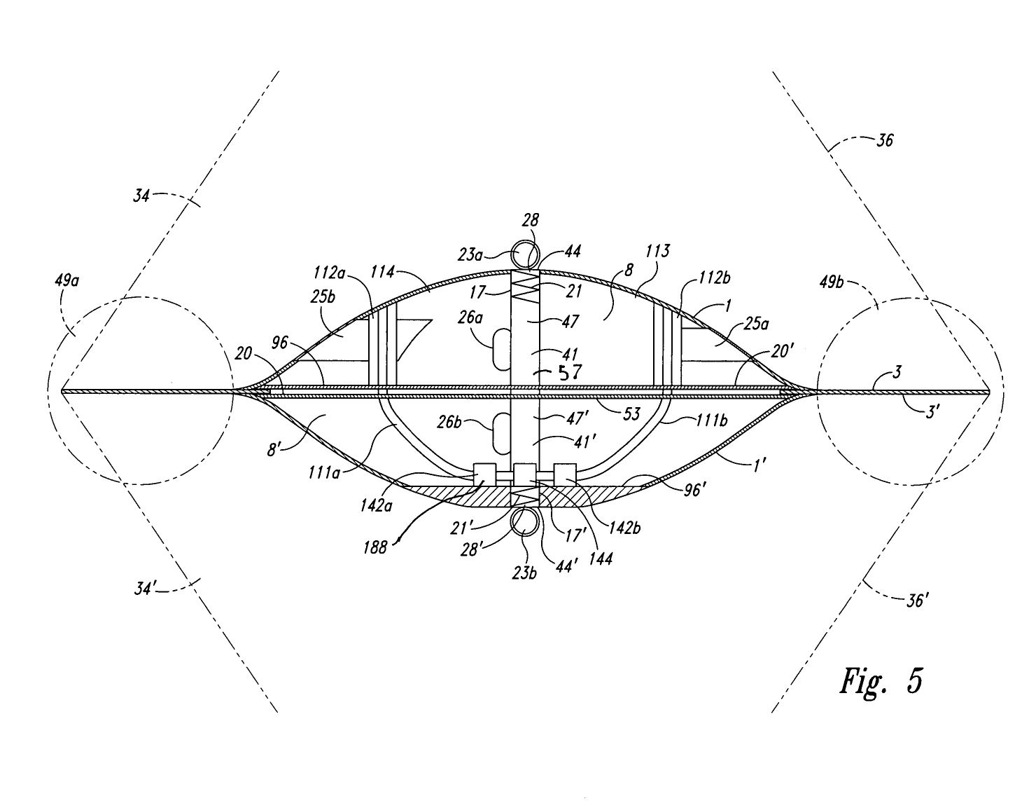

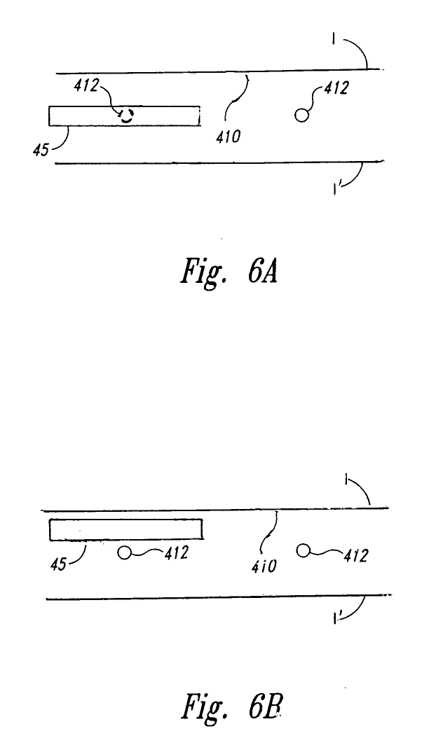

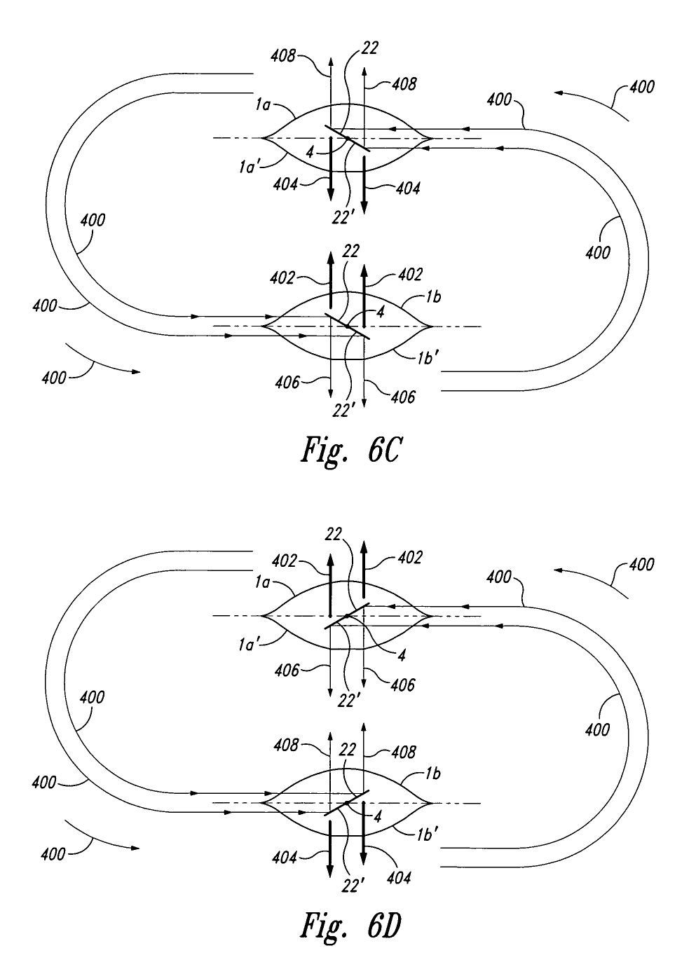

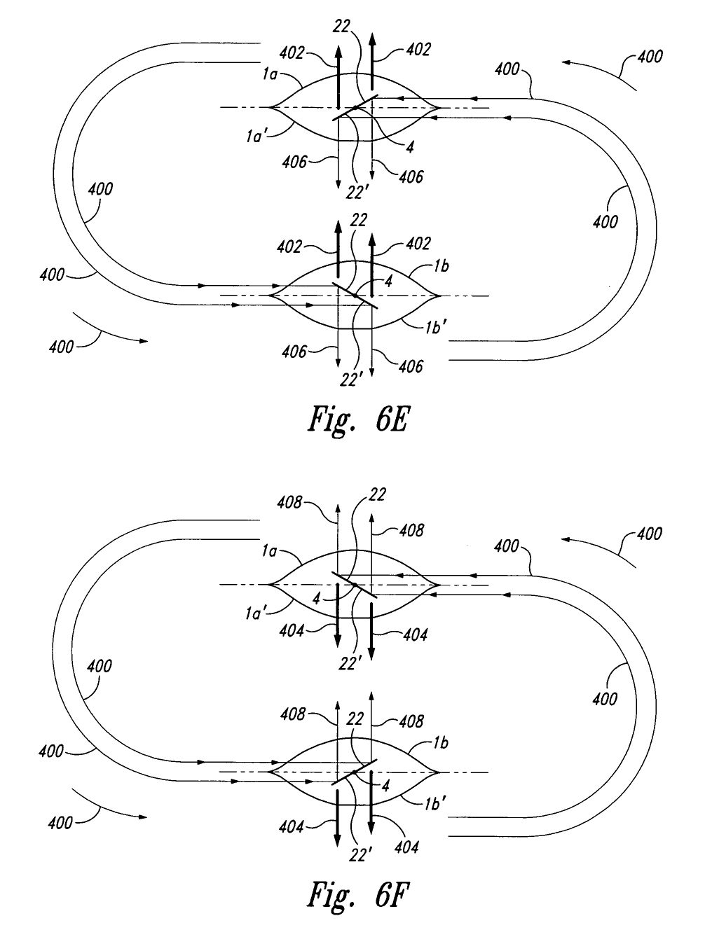

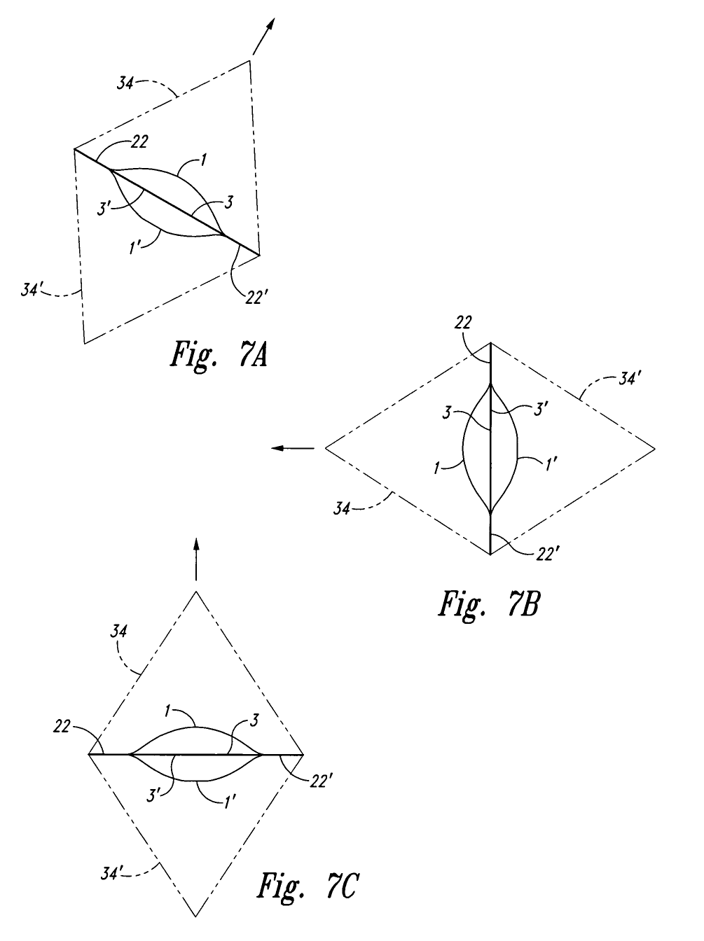

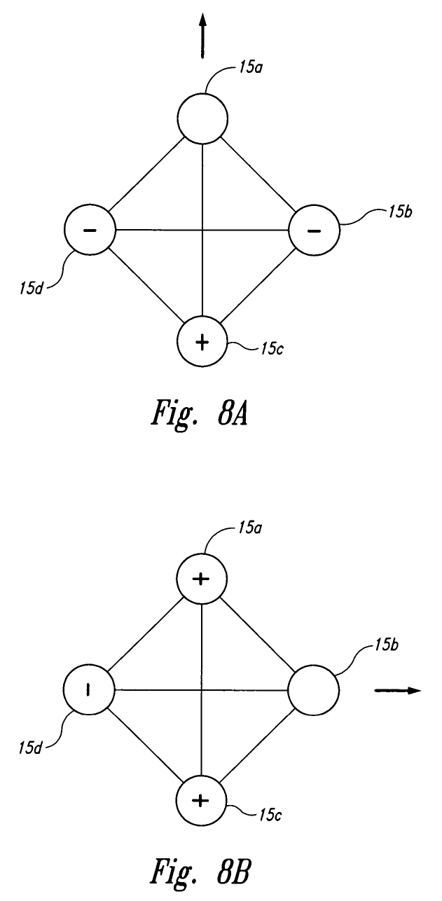

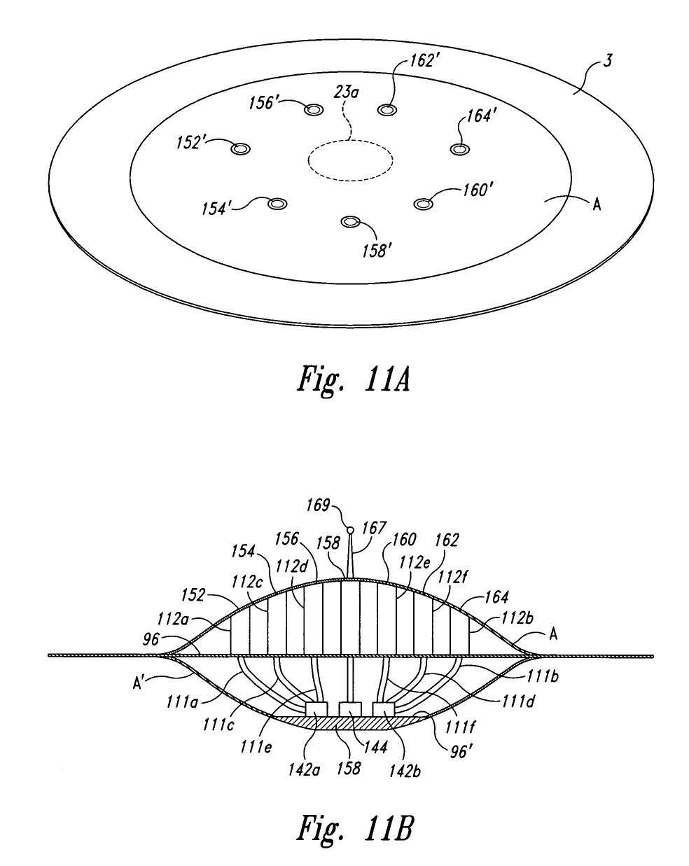

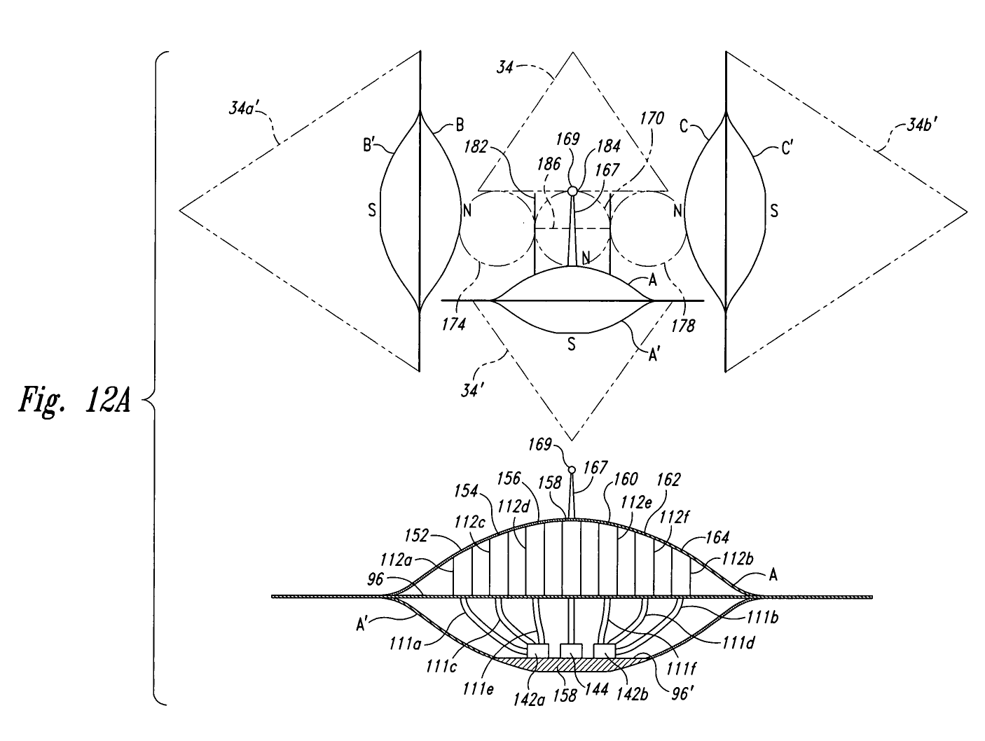

Referring to FIG. 5, barrels of water, H20, 142a and 142b are shown on the lower deck 96′ of the aircraft. A platinum electrode 188 is inserted into barrel 142a to initiate electrolysis of water into H0− ions and H+ ions. The H0− ions will drift up unbreakable glass tube 111a. The H0− ions will then enter a ferromagnetic cored column inside of a larger unbreakable glass tubular column 112a. Ions will exit this tube at roof electrode 152, FIG. 11b, as charged particles. The charged particles will then enter the parallel magnetic field lines surrounding the aircraft hull 1, 1′, FIG. 1. The magnetic field 31, FIG. 6a, of the aircraft is formed from the magnetism remaining in the ferromagnetic, chromium steel hull, and by attaching nonpermanent magnet ferromagnetic cored columns 112a and 112b, and additional cored columns depicted in FIG. 11b, cored column 112c, 112d, 112e and 112f to the craft hull 1, 1′, thereby magnetizing the hull, but not in anyway diminishing the magnetism of the permanent magnet cored columns.

The remaining ions produced from electrolysis of water, H+ ions, have drifted through adjacent unbreakable glass tubular column 111b, FIG. 5 up to ferromagnetic cored column 112b where the ions are energized and begin to rotate up to roof insulated electrode 164, FIG. 11b, spiralling and rotating around the cored column. The ions emerge from the roof electrode as charged particles. The ions have been energized, and this has in no way diminished the magnetism of the cored columns, in fact, it has increased the magnetic intensity of the cored columns as well.

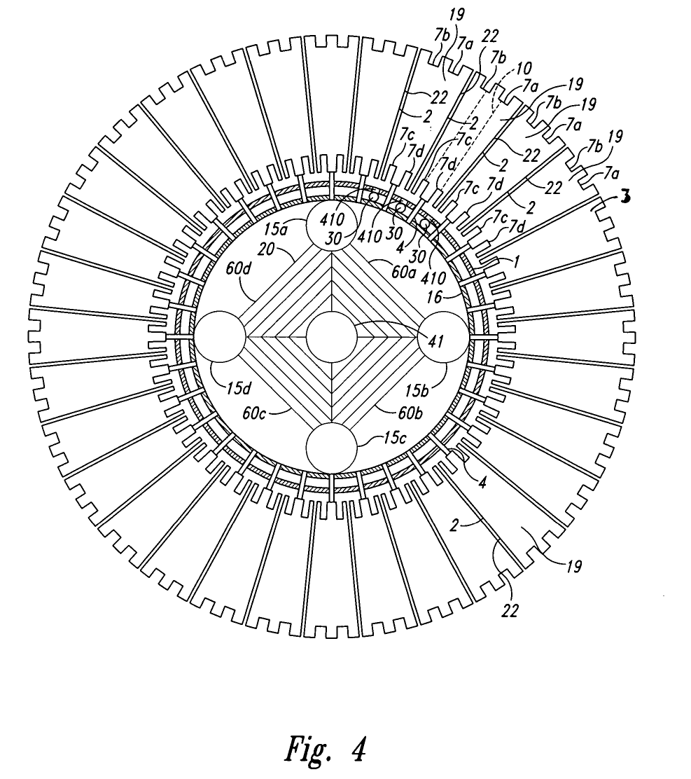

The capacitors 15a, 15b, 15c and 15d, FIG. 4, provided the stored energy for starting the platinum electrode electrolysis procedure. The capacitors also, simultaneously, provided stored energy for a capacitor-start for the encircling annular bladed ring assembly.

Referring to FIG. 5, the ions, now charged particles, will enter the parallel magnetic field lines surrounding the aircraft. The magnetic field will be from the North Pole 11, FIG. 1, to the South Pole 12, FIG. 1. The magnetic field will extend out and around the aircraft. After entering the magnetic field most of the charged particles will be warped into perpendicular Larmor gyro orbiting particle fields 34, 34′, FIG. 1, around the aircraft, and having the general appearance of a funnel shaped vortex on top of the blade assembly and a funnel shaped vortex on the bottom of the blade assembly, see FIGS. 1 and 5.

Referring to FIG. 1, a Larmor gyro orbiting particle field 34, 34′ is forming directly below the bladed ring assembly 3, 3′. A Larmor orbiting particle field is also forming on top of the bladed ring assembly. The particle field is shown as a dark band 46, 46′, FIG. 1, perpendicular, relative to the paralell magnetic field lines, particles. In reality, it would be an opaque particle field, as plasmas absorb all electromagnetic radiation in the visible spectrum, it is not reflected. For practical purposes, plasmas absorb all electromagnetic radiation. The dark band is not visible, but it is there. It is composed of heavy, positive ions and some electrons. Though, most of the electrons, being more energetic, have moved further down the rotating Larmor vortex 34′, FIG. 1, or further up, rotating vortex 34, FIG. 1. The Larmor orbiting particles are in orbits around the craft increasing in energy to the speed of light. Over time, the number of rotating particles will increase.

The Larmor gyro orbiting particle field 34, 34′ will lift the aircraft off the ground, in any direction, and accelerate it to supersonic speeds, if desired. Fuel for this device is water. In a short period of time, the vortices will increase in density of the number of particles. This will occur in a step-fashion, a more energetic band on top of a less energetic band. The bands will be of a determinate width of numerous particles in orbit. The top vortex 34, FIG. 1, the top band 42, and the bottom band, 42′, FIG. 1, will lift the aircraft off the ground. As the aircraft rises, the lower vortex 34′ also develops.

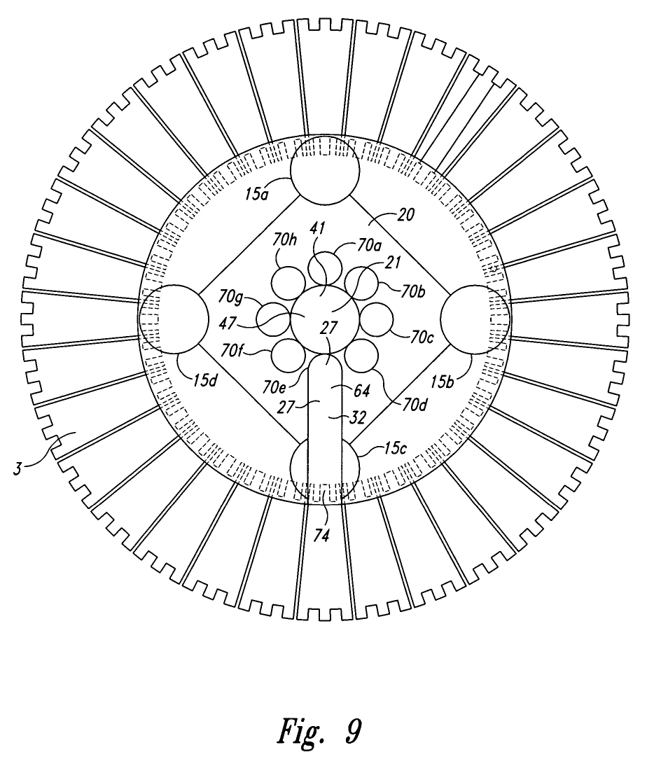

The following systems will be connected in sequence: The bladed ring assembly, 3, 3′, FIG. 4, the blade axel 4, 4′, FIG. 4, the blade axel assembly ring 16, FIG. 4, the four large capacitors 15a, 15b, 15c, 15d, FIG. 4, the electric grid plate 20, FIG. 4, the eight small capacitors 70a, 70b, 70c, 70d, 70e, 70f, 70g and 70h, FIG. 9, the inductance coil throughout the central shaft, the inductance coil 47, 47′, FIG. 5, the central shaft 41, 41′, FIG. 5, electromagnetic radiation emitted from top and bottom of craft, 44, 44′, FIG. 5, absorbtion of emitted electromagnetic radiation by the existing fields through the Debye effect, no assigned number. These systems will be matched by plasma systems operating concurrent with electrical systems: plasma 27 produced by uninsulated bladed ring assembly 3, 3′, FIG. 4, for radial plasma gun (tube) 64, FIG. 9, plasma 27 produced by electric grid plate 20 for radial plasma gun (tube) 64, FIG. 9, plasma 27 produced by the large capacitors 15a, 15b, 15c, and 15d for radial plasma gun (tube) 64, FIG. 9, plasma 27 produced by the small capacitors 70a, 70b, 70c, 70d, 70e, 70f, 70g and 70h for radial plasma gun (tube) 64, FIG. 9. As this produced plasma 27, FIG. 9, also is associated with a fluctuating direct current with an alternating current component, a large pulsed current will exist. A large pulsed current produces the most powerful plasma currents. The plasma system in this device will be the most powerful plasma system with a co-axial plasma tube.

As the electric grid plate is a conducting medium, not necessarily a current, the plasma produced from this uninsulated grid 20 will be energized to 25,000 volts, becoming charged particles, and collide with the nearest opposite particles, or, at the rate of 5,000,000 miles an hour, should rapidly be within the magnetic field of the craft, and caught up within the perpendicular Larmor gyro orbiting fields, 34, 34′, FIG. 1.

As the electric field of the aircraft is capacitor based direct current, there will be an alternating current component. The current will appear to move in one direction, but it will be moving in two directions. The initial torque in starting will evidently carry over and remain manifest, in one direction.

Unless the aircraft is in a plasma propulsion mode, 100 percent of the plasma produced will go into the Larmor gyro orbiting particle field, 34, 34′, FIG. 1. What is meant by plasma propulsion mode, is a plasma propulsion mode other than plasma based Larmor gyro orbiting particle fields.

Referring to FIG. 1, the chromium steel hull 1, 1′, of the craft will also increase in magnetizm as the rotating charged particles will affect the steel hulled craft the same as electric coils around a steel electromagnet, a steel cored electromagnet. As the energy of the Larmor orbiting particle fields increase in energy as they increase in speed to the speed of light, in a similar manner and concurrent with the increase in the energy of the particle field, an equal increase in the magnetic intensity of the chromium steel hull 1, 1′ of the craft will occur. High magnetic fields will be approached by the aircraft in this manner. These high magnetic fields will translate into equally high electric fields and electric current. Fortunately, the preferred embodiment for material for the ring assembly, tungsten cobalt alloy with zirconium, will tolerate such fields. The preferred embodiment for the field windings 10, 10′, FIG. 4, hammered tungsten wire, a conductor, can tolerate higher fields than other material. On-going research has indicated that high field conditions are approached with this material. In addition, tungsten has the highest melting point of all the metals. Tunsten, though usually brittle becomes pliable with hammering, rendering it suitable as a wire.

Referring to FIG. 7a, 7b, and 7c, various positionings of the craft and rotating vortices are shown. In order to position aircraft for rotational propulsion with the vortices, ailerons number 22, FIG. 6c have positioned the craft in direction of arrow. Increased energy to both bottom and top vortices, 34′ and 34, will result in rapid increase in speed. The increase in energy will come from the capacitance or inductance systems, 19, FIG. 4, and 28, FIG. 5.

Referring to FIGS. 6c, 6d, 6e and 6f, the aircraft 1b and 1b′ is shown in a sideview, showing the end of aileron positioned over axel 4 in FIG. 6c. On the opposite side of aircraft 1b, 1b′ is aircraft 1a, 1a′, which is a cross section side view showing an aileron 22, on the exact opposite side to aileron 22 on aircraft 1b, 1b′. The Larmor gyro orbiting particles are rotating around the two halves of the same aircraft. The particles first impact aileron 22 on aircraft 1a, 1a′, the same path of orbiting particles 400 then impact aileron 22 on aircraft 1b, 1b′, only this impact is on the opposite side from side that was impacted on aircraft 1a, 1a′. These are the two sides of the same aircraft. This is a banking procedure for this single aircraft. One aileron is turned up as shown in FIG. 6c, the aileron on the other side is turned up exactly the same, but the particles are impacting opposite sides of these ailerons even though they are turned exactly the same. In conventional aircraft, one aileron is turned up and on the other side, the aileron is turned down. The explanation for aircraft in FIG. 6c, is that the particles are moving in opposite directions on each side of the aircraft, as shown. Said ailerons are conducting, the ailerons possess a charge. The dominate charge of the orbiting particles is negative from electric current in the field windings on the ailerons. The negative current attracts the large (200 times the mass of an electron) positive charges, and repels the negative charges with repulsive force. The large attraction for positive charges results in impacts on the ailerons FIGS. 6a, 6b, 6c and 6d, at 5,000,000 miles an hour, to close to the speed of light from charged particles. The equally significant repulsive force against the equally fast, if not faster, electrons, is met by the combined repulsive force between the two negative charges with the additonal force of the particle momentum against the aileron. Abrupt maneuvering, much faster than aereodynamic forces on a conventional aileron or flap, are possible.

The opposite side of the impacted aileron is not facing the Larmor particle field flow to the same degree, the effect is less.

Referring to FIGS. 7a, 7b and 7c, propulsion or flight by use of the rotating vortices of the plasma fields 34, 34′, FIG. 1, is shown. By utilizing the ailerons for positioning the aircraft, as shown in FIG. 7a, and by increasing rotation of the ring assembly 3, 3′, FIG. 4, motional flight is commenced.

The rotational direction of the vortices 34, 34′ in FIGS. 7a, 7b. and 7c, is in the direction as indicated by arrow.

Extreme speed is possible with this mode of flight. Increase in vortex rotation leads to a lengtening of vortex.

Referring to FIGS. 7a, 7b and 7c, descent mode for rotating vortex method of propulsion begins with a descent in altitude. Flight to intended landing site is similar to a helicopter maneuver for landing. Stopping directly over intended landing site, rotation of the vortices is slowed, the slowing in rotation of the vortices will rock the craft from side to side as it slows. Energy is increased just before landing to permit a soft landing.

Referring to FIGS. 8a and 8b, utilizing capacitors as electrodes with electrode levitation as advocated by Dr. T. Townsend Brown, with the high fields this aircraft will develop, does become feasible. Such a propulsion system would provide complete silense, and, if there was absence of moonlight or the weather was overcast, completely soundless and invisible incursions would be possible. The capacitors are contained within the aircraft, they would not be visible. There is movement toward the more highly charged electrode. Dr. Brown demonstrated the effect, and has numerous patents pertaining to his invention. He lacked extremely high fields, this invention will make possible this form of propulsion. FIGS. 8a and 8b show movement in the direction of the more highly charged electrode. In this example, the capacitors most high charged are encircled with “rays”. The one capacitor (electrode) least highly charged, is opposite from direction of movement.

Referring to FIG. 9, the aircraft has a fluctruating direct current with a large, pulsed current. Plasma 27 will be produced by ionization on the electric grid plate 20, FIG. 4. A co-axial plasma gun 64 will extend from one of the eight small capacitors, 70a, 70b, 70c, 70d, 70e, 70f, 70g, and 70h, surrouding the crew access tube 21, 21′, FIG. 5, to an opposing large capacitor 15c, FIG. 4, a co-axial electrode. The plasma 27 will run the length of the tube 64. A strong plasma current 27 will run the length of the tube 64 as a radial electric current is moving with it. This prolongs the Lorentz force in combination with the magnetic field. The plasma 27 will eject at the outer end 74 of tube 64. Utilizing the Lorentz force, the craft will be propelled with extreme speed. The plasma tube 64 can be moved to any location around the perimeter of the craft.

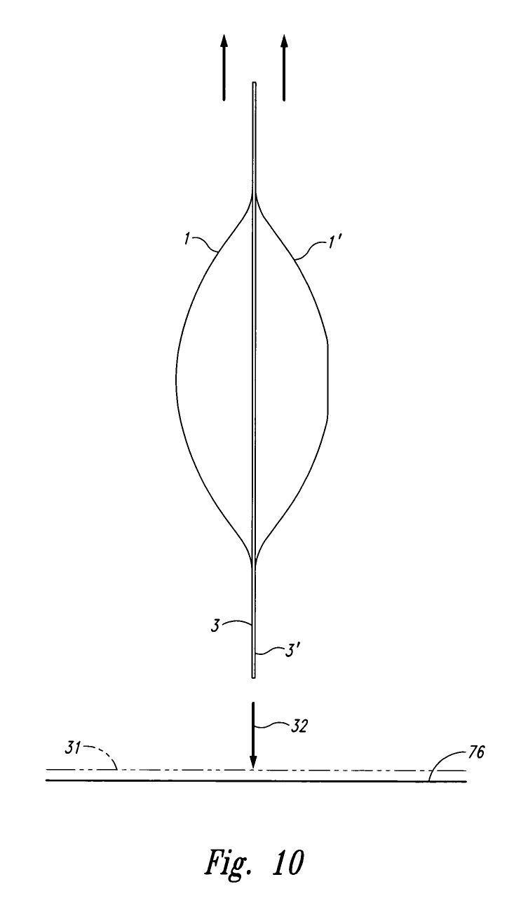

Referring to FIG. 10, the aircraft is shown in a perpendicular position relative to the Earth 76. In this position, the electric field of the craft is interacting with the Earth's magnetic field at a ninety degree right angle, resulting in maximum repulsive force between the craft's electric field and the magnetic field of the Earth. The high fields of this aircraft, make this form of propulsion possible. Extreme acceleration perpendicular to the Earth 76 is possible in this mode of propulstion. If the craft were strong enough, with this electric force, the craft could lift a battleship. The aircraft will have this electric force.

The high magnetic field induced in the aircraft by the rotating Larmor gyro orbiting particles will also increase the electric field in the bladed ring assembly 3, 3′, FIG. 1. The chromium steel hull 1, 1′, FIG. 1 will be magnetized like an electromagnet.

### End of Operation Section of Aircraft Preferred Embodiment

Beginning a Description of the Preferred Embodiment of aircraft, as follows. Referring to FIGS. 1, 2, 3, 4 and 5, a preferred embodiment of the Multi-functional Aircraft (MFA), also called the “aircraft”, or “craft”, or “device” according to the present invention is shown. The aircraft is comprised of a body hull 1, 1′, FIG. 1, comprising a top half hull 1, FIGS. 1 and 2, and a bottom half hull 1′, FIGS. 1 and 3. A conducting bladed ring assembly 3, 3′, FIGS. 1, 2 and 3, is mounted between the top and bottom half hulls 1 and 1′. An individual blade 2, 2′ is shown in FIG. 4, attached pivotally by conducting axel 4 to conducting blade attachment ring 16, FIG. 4. All 32 of the blades in the bladed ring assembly 3, 3′ are pivotally attached to conducting attachment ring 16. The conducting attachment ring 16 is further connected to four large capacitors 15a, 15b, 15c and 15d, FIG. 4. Said four large capacitors are in turn connected to electric grid plate 20, FIG. 4.

A plurality of eddy currents 62, FIG. 4, on conducting grid plate 20, are present in all four quadrants, 60a, 60b, 60c and 60d of the grid plate, showing a representation of varying movement of said eddy currents. The eddy currents in the conducting grid plate are due to the fixed conductor in changing magnetic fields. Referring to FIG. 1, window 25a provides visibility for pilot. Window 25b provides rear visibility for pilot and crew members. The North Pole 11 is shown, and the South Pole 12, is also shown. A flat, soft landing surface 43 is provided on bottom of craft. Landing gear 6a and 6b are hydraulic and retractable into area beneath the floor of the lower deck 96′.

The top most point on the top vortex 34 is apex 55, on the bottom vortex 34′, it is apex 55′. An overhanging edge of the hull, a lip, 5, 5′, permits any accumulated pooled current, electric charge on top and bottom of craft to be exhausted onto the annular ring surface 3, 3′.

Referring to FIG. 4, blade notches 7a, 7b, 7c and 7d and 7a′, 7b′ 7c′ and 7d′ are for field windings 10, 10′, with the current enterring field windings at weak current entrance 9a, and exiting at strong current exit 9b. Preferred embodiment for wire for field windings 10, 10′ will be hammered tungsten wire over a blade core 19, 19′ of tungsten, cobalt zirconium alloy. Said blades 2, 2′ also act as ailerons 22, 22′ for navigation of aircraft. Nozzles 30, 30′ are placed between individual blades, above and below blades on the hull exterior surface 1, 1′, The nozzles are to extinguish fire or incipient combustion forming on blades due to high temperatures. Openings 410, FIG. 6b, are to extract and replace blades through said opening. Landing gear 6a, 6b, 6c and 6d are shown in FIGS. 1 and 3. Landing gear can be extracted into and out of area beneath lower deck 96′ floor. Shown in FIG. 3 is a soft landing surface 51, indicated by circular dash lines on bottom of craft hull 1′.

Referring to FIG. 5, circular, induced magnetic field 49, surrounds ring current 3, 3′. An upper deck floor 96 and a lower deck floor 96′ are shown. The top of the electric grid plate 20, is shown on the planar surface of the top of the bottom half of hull 1′. Interior walls of hull 1, 1′ are covered with an octoganal structural frame of beehive configuration, 8, 8′, FIG. 5, of the same material as hull 1, 1′. Pressurized cabin doors are shown for access to lower and, upper deck. Cabin door to lower deck 26b and upper deck cabin door 26a from crew access tube 21, 21′. The crew access tube also serves as a central support shaft 41, 41′ for both upper and lower hulls. The crew access tube 21, 21′ also serves as a pressure release tube 17, 17′ during a nuclear fusion reaction process. The crew access tube 21, 21′, also serves as a surface for electric coil 28, 28′, and also has recessed, curved hand and foot bars 57.

Unbreakable glass tubular columns for H0− ions 111a are indicated on left side of aircraft. Unbreakable glass tubular columns for H+ ions 111b are shown on the right side of aircraft. Platinum electrodes 188 within a barrel of H20 142a, are shown for left side on lower deck floor 96′. On the right side of lower deck floor 96′ is a barrel for electrolysis, and also in the middle of lower deck floor 96′.. The barrel on the left containing H20 will be electrolyzed into H0− ions and H+ ions which are the fuel for the aircraft. H0− ions will ascend on the left, H+ ions will ascend in the tubular columns on the right.

The pilot window 25a is shown. Also shown is rear window 25b for pilot and crew. Circular hatch doors 23a and 23b are shown, 23a shown leading from crew access tube 21 to top of hull 1, hatch door 23a. Also coming from crew access tube 21 is hatch door 23b to bottom hull 1′. The central shaft 41, 41′ will contain the induction coil throughout during operation of the aircraft.

Referring to FIG. 5, engineer control panel 114 is shown on upper deck. Shown on lower deck floor 96′ is a barrel of water 142a for electrolysis by platinum electrode 188. A barrel of B-11 isoteop solution 144, and another barrel of H20 142b are shown. The nonbreakable glass tubular column 111b is for H+ ions. Electric grid plate 20, FIG. 4 is on top planar surface 29, FIG. 4 of bottom hull 1′. The grid plate 20 is shown in FIG. 5 between the two hulls 1, 1′

Referring to FIG. 5, the Larmor gyro orbiting particle field 34, 34′ is shown, as is the Langmuir sheath 36 36′ on the sur_face of the plasma field 34, 34′.

Referring to FIG. 6a, the angle of intersect of the magnetic field 31 and the electric field 32 is shown. The two fields form a ninety degree right angle. The magnetic field of the aircraft and the electric field of the aircraft are also at right angles, with the electric field horizontal with the earth. The magnetic field 31 of the aircraft, and the electric field 32, as shown also apply to the aircraft hull 1, 1′.

The large capacitors in FIG. 4, 15a, 15b, 15c and 15d are connected to the eight small capacitors 70a, 70b, 70c, 70d, 70e, 70f, 70g and 70h, FIG. 9. The small capacitors in turn are connected to the inductance coil 47, 47′ within the central shaft 41, FIG. 5. The inductance coil in turn emits electromagnetic radiation, 44, 44′, as shown on both the top and bottom of craft from electrode 158, 158′. The electromagnetic radiation 44, 44′ FIG. 5, will be with overarching vortices 34, 34′, FIG. 1.

The electromagnetic radiation 44, 44′ will be absorbed by the Debye effect 46, 46′, best shown in FIG. 1.

Referring to FIG. 6b, a hole 412 in the side of the hull 1′, to insert axel 4, FIG. 4, is shown. The hole 412 is located below the rim of the lower hull 1′. After inserting the axel 4 through the hole, it is then attached to the blade attachment ring 16, FIG. 4. The hole will be insulated as the axel 4 is a conducting axel. The end of blade 2, 2′, FIG. 4 is shown in opening 410 in hull 1′ to extract or replace a worn, or smoking blade. The hull opening 410 is located below the rim of hull 1′. The opening 410 also contributes to cooling for blade 2, 2′.

Referring to FIG. 6c, a single aircraft is shown. A side view of half of the craft 1b, 1b′, and a cross section of the remaining half 1a, 1a′ is shown. The blade on axel 4 (or aileron 22) for aircraft 1a, 1a′ is slanted as indicated, the front half of blade is slanted down, the rear half of blade is slanted up. Moving charged particles 400 in Larmor gyro orbits around aircraft are shown. Particles 400 impact the bottom of the blade on axel 4 on aircraft 1b, 1b′ and are reflected downward 406 on entire bottom portion of blade on axel 4. The bottom impact on blade by particles 400, produces an opposite and equal reaction movement in the opposite direction. The blade and the aircraft on half of aircraft 1b, 1b are moved upward. On the opposite side of aircraft 1a, 1a′, the orbiting particles are now moving in the opposite direction relative to aircraft 1b, 1b′. The blade on aircraft 1a, 1a′ is in the same position as the blade on the opposite side of aircraft 1b, 1b′. The moving particles 400 are now impacting the top of the blade and are reflected upward 408, at the same time the blade and the aircraft are moved downward 404. This opposing movement on each side is a banking maneuver. It is similar to conventional aircraft, but it is an entirely new method of navigation. The blade at axel 4 will move upward into a more energetic particle orbit, and the other half of blade move downward into a more energetic particle orbit. The result will be instantaneous banking of the aircraft.

Referring to FIG. 6d, a single aircraft is shown. A side view of bottom aircraft, and a cross section side view of top half of top aircraft is shown. The moving charged particles 400 are impacting the top of blade between axel 4. Particles are reflected upward 408, opposite opposing: force is downward 404. The opposite side of same aircraft, cross sectional view of side, the moving charged particles 400 impact the blade between axel 4 on the bottom. The particles are deflected downward 406, a reactive force upward 402, banks the aircraft upward on the left, assuming the aircraft is traveling to the right.

Referring to FIG. 6e, bottom aircraft is one side of an aircraft. The opposite cross sectional view of the side of the top aircraft, is shown. Both views, top and bottom, are of one aircraft. Charged particles 400 are impacting blade at axel 4 impacting blade (aileron) on the bottom deflecting downward 406, the same particle orbit impacts the top aircraft aileron at axel 4 deflecing downward 406 with a reactive force upward 402, the aircraft will ascend in altitude. This operation is similar to the increase or decrease in altitude by the use of elevators in conventional aircraft. Elevators located in the tail section.

Referring to FIG. 6f, a moving charged particle field represented by arrowed lines is impacting aircraft 1b, 1b′ on the top of the aileron on axel 4 deflecting particle upward 408, with a equal and opposite reactive force downward 404. The gyro orbiting charged particles impact aircraft 1a, 1a′ on the top surface of aileron on axel 4 deflecting upward 408 with an equal and opposite force downward on ailerons and aircraft.404. The aircraft will descend in altitude.

Referring to FIG. 7a, a field of Larmor orbiting particles around aircraft hull 1, 1′ is shown. The aircraft in FIG. 7a has been positioned in the direction of the arrow by use of ailerons 22, 22′, FIG. 2. The rotating vortices will move the aircraft in the direction indicated by arrow. Increased energy to rotating vortices 34, 34′ will increase length of vortex 34′ and also increase the rate of rotation of both vortices, and will also increase the rate of travel, the speed of the aircraft.

Referring to FIG. 7b, an aircraft with hull 1, 1′ has been positioned in a horizontal position relative to the earth in direction of travel indicated by arrow. The aircraft has been positioned in a horizontal position by ailerons 22, prior to acceleration. The rotating vortices will move the aircraft in the direction indicated by the arrow. Increased energy to rotating vortices 34, 34′ will increase length of vortices and also increase the rate of rotation of both vortices 34, 34′, and will increase the rate of travel, the speed of the aircraft.

Referring to FIG. 7c, an aircraft is shown having been positioned in a vertical position by ailerons 22,22′. Direction of travel is indicated by arrow. The aircraft is in a position perpendicular to the earth. The aircraft has been positioned by ailerons 22 prior to acceleration. The rotating vortices 34, 34′ will move the aircraft at increasing speed as the speed of rotation of the vortices increases. The vortices 34, 34′ will also increase in length as rotation increases.

Referring to FIGS. 7a, 7b, and 7c, descent mode for rotating vortex method of propulsion begins with a descent in altitude. Flight to intended landing site is similar to helicopter maneuver for landing. Stopping directly over intended landing site, rotation of the vortices is slowed, the slowing in rotation of vortices will rock the craft from side to side as it slows. Energy is increased just before landing to permit a soft landing. Descent is in the vertical mode, FIG. 7c.

Referring to FIG. 8a, motional movement of an aircraft by use of an array of capacitors, is shown. In this instance, the capacitors are performing as electrodes. Capacitors 15a, 15b, 15c and 15d are shown. The single capacitors 15d and 15b are indicated as being negatively charged, and capacitor 15c is indicated as being positively charged. Capacitor 15a does not have a charge. Direction of movement will be as indicated by arrow, in this instance, in the direction of the more highly charged electrodes 15d and 15b.

Referring to FIG. 8b, the capacitors (electrodes) 15a and 15c are indicated as more highly charged that the oppositely charged capacitor (electrode) 15d. Capacitor 15b does not have a charge. Movement will be in the direction of more highly charged electrodes as indicated by arrow. The fluctuating direct current utilized by the capacitance system, is a positive factor in applying potentials. The capacitors are circular in shape.

Referring to FIG. 9, a radial plasma tube 64 (or gun) for plasma propulsion is shown. The tube entrance for plasma to be accelerated is shown. Eight small capacitors 70a, 70b, 70c, 70d, 70e, 70f, 70g and 70h surround the central shaft 21. Plasma tube 64 is connected to capacitor 70e at the central shaft end, and large capacitor 15c at exit end 74 of tube 64. Operation of the radial plasma gun 64 was explained in the operations section, preceding this section. The plasma tube 64 (or gun) can be connected to any of the large capacitors 15a, 15b, 15c and 15d, and also connected to any of the small capacitors 70a, 70b, 70c, 70d, 70e, 70f, 70g and 70h.

Referring to FIG. 10, the aircraft is shown positioned perpendicular with the Earth 76. The electric field 32 of the ring is in the direction of the arrow toward the earth. The electric field 32 of the ring will interact with the Earth's magnetic field with a strong repulsive force. The high fields of the aircraft will make possible rapid ascent. The only limitation on potential speed will be the physical limitations of the crew and structural limitations of the aircraft to withstand the resultant g forces. The electric force is the maximum force attainable by our technology. This aircraft will make possible our use of this tremendous force. At extremely high speeds in space, which this craft can attain, near the speed of light, the magnetic force becomes co-equal with the electric force. In space this aircraft will utilize particle acceleration to attain high speed over time, months to a year. Fuel will be stored in 16 large capacitor plates as plasma. The aircraft can immediately be used in space, or as a submersible device, lifting device, or boring device.

### End of Description of the Preferred Embodiment for Aircraft

Beginning of the Operation of the Process Portion of this patent as it relates to a nuclear fusion energy process utilizing the aircraft, will be described first, followed by a description of the preferred embodiment for the nuclear fusion energy process. The fusion energy portion of this patent is a process, more specifically, it is a method for producing electricity from a nuclear fusion reaction without significant radiation produced, or cooling required, using the fuels B-11 isotope and regular hydrogen.

A spherical plasma containing the requisite fuels is required for the fusion system, as well as the coordinated positioning and functioning of three separate aircraft of the type described in the preceding description of the preferred embodiment for the aircraft. The three aircraft to be utilized have similar operating systems, the aircraft vary in size.

A cone shaped pyramidal column 167, FIG. 11b, will be raised on the roof of the smaller aircraft prior to beginning the fusion process. A glass ball electrode 169, FIG. 11b, is situated on top of the pyramidal shaped column 167. The ball electrode is slotted and air cooled. Raising the cone 167 will induce a magnetic field within the applied magnetic field. The induced field will be on the roof of the smaller aircraft A, A′, FIG. 11b, By positioning two similar in operation, but larger in size aircraft, on each side of the horizontal smaller aircraft, A, A′, and perpendicular to the smaller aircraft A A′ the process can proceed. The Positioning of the aircraft is a method for obtaining the pressure and compression for ignition of the spherical plasma 170, FIG. 11b, as the process proceeds.

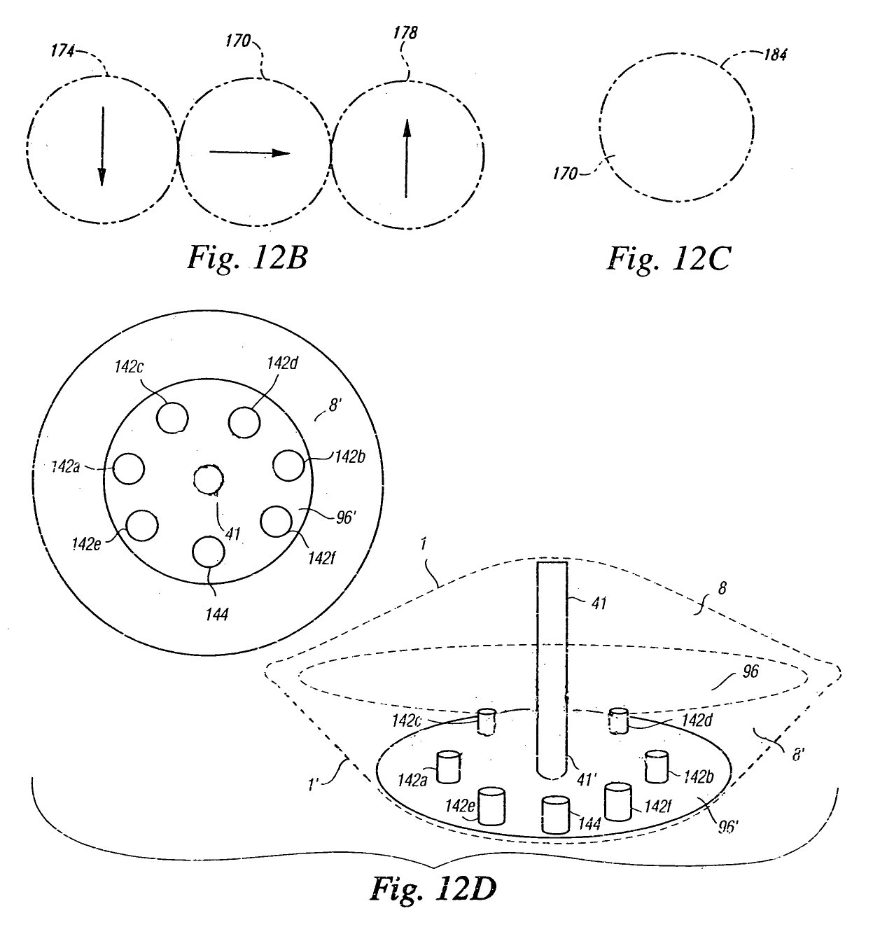

The larger aircraft on the left of horizontal aircraft A, A′, is perpendicular aircraft B, B′, FIG. 12a. The larger aircraft on the right of horizontal aircraft A, A′ is perpendicular aircraft C, C′, FIG. 12a. The larger aircraft will also have spherical plasmas on the roof of the aircraft. Spherical plasma 174, FIG. 12a is on the roof of aircraft B, B′, Spherical plasma 178, FIG. 12a is on the roof of aircraft C, C′. The fusion spherical plasma, 170, is on the roof of aircraft A, A′. Spherical plasma 170 contains the fusion fuels B-11 isotope and regular hydrogen. By positioning the larger aircraft perpendicular to the smaller Perpendicular aircraft B, B′ and perpendicular large aircraft, C C′, by positioning themselves perpendicular to the smaller aircraft A, A′, have placed their spherical plasmas on top of the smaller aircraft A, A′, spherical plasma 174 from aircraft B, B′, and spherical plasma 178 from aircraft C, C′, as shown in FIG. 12a. Spherical plasma 178 and 174 abut the induced Larmor gyro orbiting particle field from opposite sides. The fusion spherical plasma 170 is within the tightening Larmor orbiting partical field 182, FIG. 12a. There is also an induced electric field 186, FIG. 12a within the tightening Larmor orbiting field 182.

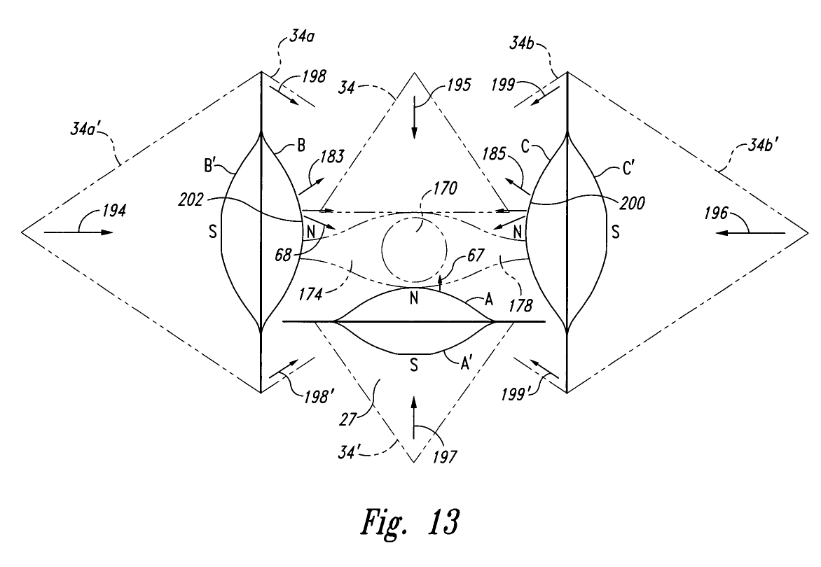

The ball electrode 169 has increased the intensity of the induced electric field through emitted electromagnetic radiation absorbed in part by the induced electric field. The electromagnetic radiation 44, 44′, FIG. 5, is from the inductance coil 28, 28′, FIG. 5, part of the aircraft's oscillatory circuit. The pyramidal cone shaped column 167 was raised over the usual exit electrode 158, FIG. 5 for the inductance coil 28, 28′ top emissions, 44. The bottom rotating plasma vortex 34′ of aircraft B, B′ and the bottom rotating plasma vortex 34′ of aircraft A, A′ by increasing their rotational rate are applying pressure from both sides on central fusion spherical plasma 170. The rotational direction of plasma 174 is perpendicular to the rotational direction of fusion spherical plasma 170 and is in the opposite direction to the rotational direction of spherical plasma 178. These opposing rotational directions added to the pressure from the rotating vortices squeezing the spherical plasma 174 and 178 on both sides of fusion spherical plasma have squeezed the rotating charged particles in the Larmor orbiting field into the fusion spherical plasma 170. At the same time the induced electric field with highly energized particles has been squeezed into the fusion spherical plasma 170. The rotating spherical plasmas 174 and 178, FIG. 12b have been squeezed into an amorphous mass around fusion spherical plasma 170, best seen in FIG. 13. At the same time, the circular magnetic fields around the ring current 4, 4′ on each aircraft are concentrating the three magnetic fluxes all intersecting, with resultant increase in temperature albeit electron volt temperature. Heat is still being added from the ball electrode 169, the rotating vortices are still increasing pressure. There are other pressure and heat sources, the bottom vortex 34′ of aircraft A, A′ to a degree pushing against repulsive magnetic forces from opposing North Poles on all three aircraft.

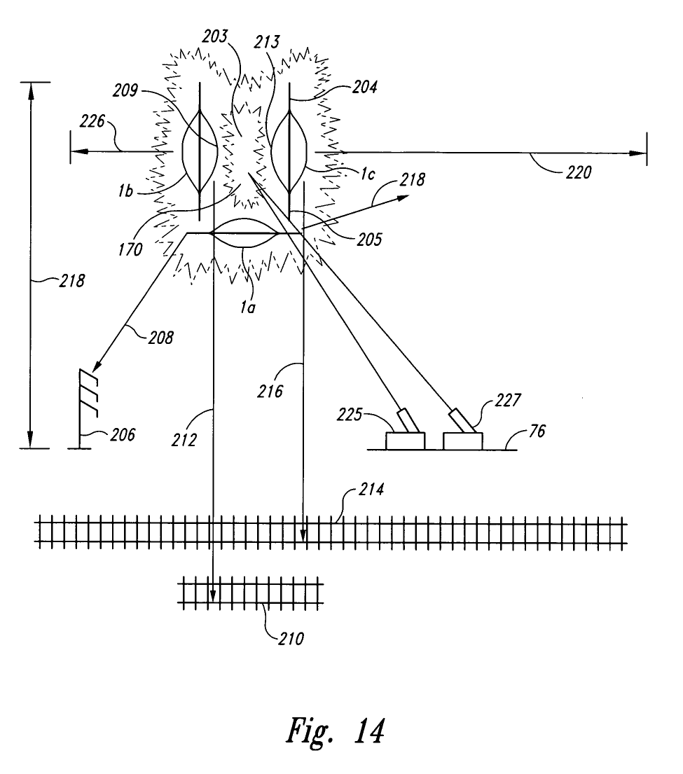

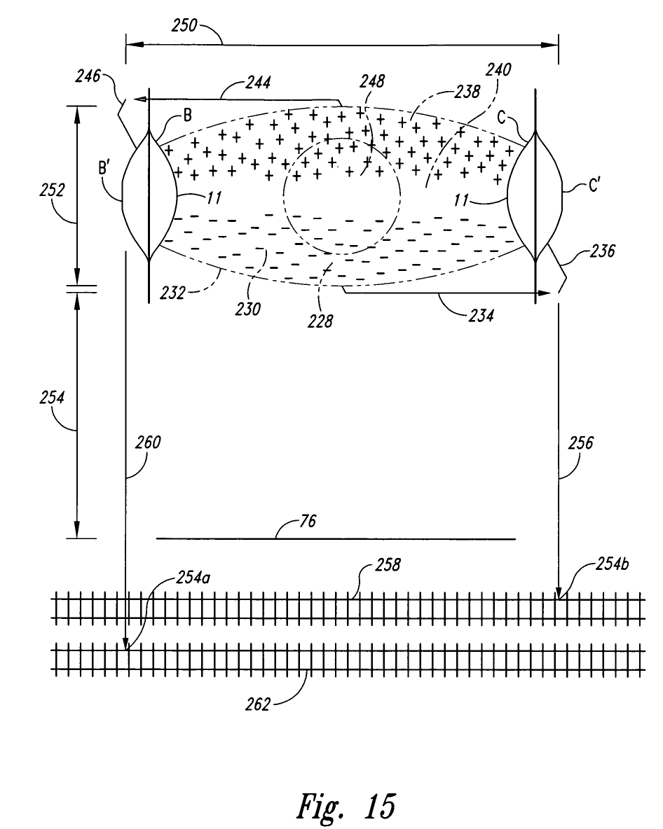

The time is opportune for ignition by land-based neutral beam 225 or high power laser 227, FIG. 14. At the moment of ignition of fusion spherical plasma 170, there will be an appearance of flames, though it is primarily harmless photon energy, rather than heat. The aircraft will be grounded, aircraft C will be blown and move itself to the right 120 feet, aircraft B will be blown and move itself to the left 30 feet, aircraft A will be blown and move itself 100 feet to the right behind plasma cloud. The end phase is shown in FIG. 15. The energetic charged particles created in the nuclear fusion reaction are positioned between the two large aircraft. A failed attempt at organizing in the center of the plasma cloud leads to collapse and what ensues is known physics for formation of a storm cloud with resultant lightning bolts as the strom cloud collapses and the two large aircraft collect the huge lightning bolts, different charged bolts going to each aircraft positioned to receive either positive bolts or negative bolts with lightning rods in effect. The energy can be stored or transferred to power distribution superconducting ring by microwave or directly from aircraft if within immediate proximity.

### End of the Operation of the Process Portion of this Patent

Beginning of Description of the Preferred Embodiment for the Process Portion of this patent as it relates to a nuclear fusion reaction process or method for producing electricity from a nuclear fusion reaction without significant radiation produced, or cooling required, using the fusion fuels B-11 isotope and regular hydrogen. The “11” in B-11 isotope is the “neutrons”, and, as all boron has five protons, the correct designation for this isotope would be ₅¹¹Boron, or ¹¹Boron. However, convention=ally it is called B-11 isotope, or B-11. Either B-11, or B-11 isotope will be used to discuss the B-11 isotope, though it has been correctly identified. The Hydogen atom is one proton and one electron. The correct designation is ₁¹H, or H. But conventionally, it is written H-1. Though it has been correctly identified as H, it will be referred to conventionally as Regular Hydrogen, or H-1. Particularly, since the ion H+ is, in reality only a single proton, but it is also the Hydrogen Atom without electrons, and is designated H+ which is contrary to logic since Regular Hydrogen, H-1, has a proton and an electron, and is designated only H. Conventionally in discussing the single atom of Hydrogen it is called H-1, though it has been correctly designated as H, it will be referred to conventionally as H-1. In the preceding utility portion of this patent, the aircraft was also called “craft” and also “device”. In the remaining nuclear fusion energy portion of this patent, the aircraft will be designated Device A, being the smaller aircraft. Two larger, similar devices are designated Device B and Device C.

Referring to FIG. 11a, a top perspective view of the top surface of Device A is shown. Electrode apertures are shown for H0− ions 152′, H-1 ions (atoms) 154′, H-1 ions 156′, inductance coil electromagnetic radiation 158′, B-11 isotope 160′, H-1 ions 162′, H+ ions 164, and pressure release hole cover 23a. Aircraft or Device A is shown, ring assembly 3, 3′ is also shown.

Referring to FIG. 11b, a cross-section side view of Device A is shown. Fifty gallon drum barrels of prepared solution for electrolysis are shown on lower deck 96′. Left barrel is solution for H-1 ions 142a, middle barrel B-11 isotope 144, right barrel H+ ions 142b. Left barrel solution is also for H0− ions, right barrel is also for H-1 ions.

Barrel 142a is connected to unbreakable glass tubular column 111a which is connected to ferromagnetic cored column within a larger unbreakable glass tubular column 112a, connected to exit electrode 152. Unbreakable glass tubular column 111c is connected to barrel 142a and is also connected at a higher end to ferromagnetic cored column within a larger unbreakable glass tubular column 112c, connected to exit electrode 154. Unbreakable glass tubular column 111e is connected to barrel 142a at one end, at a higher end it is connected to ferromagnetic cored column within a larger unbreakable glass tubular column 112d, connected to exit electrode 156. Barrel 144 is connected to unbreakable glass tubular column 111f, which is connected to ferromagnetic cored column within a larger unbreakable glass tubular column 112e, connected to exit electrode 160. Barrel 142b is connected to unbreakable glass tubular column 111d, which is connected to ferromagnetic cored column within a larger unbreakable glass tubular column 112f, connected to exit electrode 162. Barrel 142b is connected to unbreakable glass tubular column 111b, which is connected to ferromagnetic cored column within a larger unbreakable glass tubular column 112b, connected to exit electrode 164. Barrel 142a contains solution for H0− ions and H-1 ions. Barrel 144 contains solution for B-11 isotope. Barrel 142b contains solution for H-1 ions (atoms) and H+ ions.

Also shown is a conical, pyramid shaped cone 167, topped with a glass, air cooled, slotted ball electrode 169. The cone 167 is raised at the beginning of the fusion process.

Referring to FIG. 12a, shown is a side view of three devices (aircraft). One device, Device A (aircraft A) is exactly the same as referenced “device”, also called “craft), or “aircraft”, in previous portions of this patent. Device B and C are the same as Device A except they are larger in size. Device B, B′ is perpendicular on the left of Device A, A′ which is horizontal. Device C, C′ is perpendicular to Device A, A′ and is on the right side of Device A, A′. Spherical plasma 174 is on top of Device B, the main, fusion spherical plasma 170 is on top of Device A, a spherical plasma 178 is on top of Device C.

Referring to FIGS. 11a, 11b and 12a, H-1 ions are in barrel 142a, B-11 isotope is in barrel 144 and H-1 ions are in barrel 142b. Ions ascend through unbreakable glass tubular columns from H-1 barrel 142a tubular column 111e drifts to ferromagnetic cored column within unbreakable glass tubular column 112d to exit electrode 156, to roof exit electrode 156′, whereupon, having been placed into mini-Larmor gyro orbits around the ferromagnetic column 112d, the ion emerges as a charged particle in a mini-Larmor gyration on top of the Device A. Ions in tubular column of unbreakable glass 111c drifts to ferromagnetic cored column within unbreakable glass tubular column 112c to exit electrode 154, to roof exit electrode 154′, whereupon, having been placed into mini-Larmor gyro orbits around the ferromagnetic column 112c, the ion emerges as a charged particle in a mini-Larmor gyrating orbit on top of the Device A.

Referring to FIGS. 11a, 11b and 12a and 12b B-11 isotope ions, drift through unbreakable glass tubular column 111f to ferromagnetic cored column within unbreakable glass tubular column 112e to exit electrode 160, to roof exit electrode 160′, whereupon, having been placed into mini-Larmor gyro orbits around the ferromagnetic column 112e, the ion emerges as a charged particle in a mini-Larmor gyrating orbit on top of Device A. The B-11 isotope is the primary fuel for the fusion process. At this stage, there are three fuels, two H-1 ion sources, and one B-11 ion source, organizing into a spherical plasma on the top of Device A. H-1 ions in barrel 142b ascend through unbreakable glass tubular column 111d to ferromagnetic cored column within unbreakable glass tubular column 112f to exit electrode 162, subsequently to roof exit electrode 162′. All of the fusion fuels have now exited top electrodes and are in merging gyro orbits on the top of Device A, forming a fusion spherical plasma.

After beginning the initial “start” procedures, to begin operation of the device, only H0− ions and H+ ions were utilized. At that stage, the ferromagnetic columns were not sufficiently magnetized to impart mini-Larmor gyro orbits to the charged particles, the particles, therefore, were able to enter the applied magnetic field of the aircraft. This would indicate that the later characteristics of a permanent magnet are short-lived, the ferromagnetic cores would be a soft steel, or even soft iron. Technically, that would not be a permanent magnet. A permanent magnet is hard steel, or other alloy. Preferred embodiment for device has to be weighed with other characteristics of steel and iron. Iron, cast iron, has the highest compression strength of all the metals. This device if used as a submerisible device will be subjected to extreme compression. The many ferromagnetic columns could provide substantial structural strength.

Iron fractures, soft steel would be preferred embodiment for the ferromagnetic cored columns. The ferromagnetic cored columns are not permanent magnets.

Referring to FIG. 11a, the pyramid shaped columnar cone 167 is positioned over exit electrode 158′ on top of Device A. By the method of positioning large Device C, perpendicular, on the right side of Device A which is horizontal to the ground, and positioning Device B, perpendicular, on the left side of Device A, the spherical plasma 170, designated for fusion reaction is now being pressured from both sides. Device B is pushing spherical plasma 174 against fusion spherical plasma 170. On the other side, Device C is pushing spherical plasma 178 against fusion spherical plasma 170. The conical, pyramid shaped cone 167, FIG. 11b, having been raised: on top of Device A, has induced a magnetic field within the applied magnetic field on top of Device A. At the same time an induced electric field 186 has been formed around the fusion spherical plasma 170. A rotating current 186 forms in large part due to energy from electromagnetic radiation from ball electrode 169 immediately over and adjacent with fusion spherical plasma.

Referring to FIG. 12b, the rotational directions of the three spherical plasmas 174, 170 and 178 are shown. Viewing the three spherical plasmas. 174, 170 and 178, from the center spherical plasma 170, the left spherical plasma 174 is rotating in the opposite direction to spherical plasma 178 and perpendicular to spherical plasma 170. The three spherical plasmas are rotating in different directions, all adjacent to fusion spherical plasma 170. There will exist an increase in temperature due to rotational friction, though it translates into electron volt temperature, primarily. When spherical plasma 174 and 178 are compressed into spherical plasma 170, at that time the varying rotational directions of the contained, rotating charged particles will dramatically increase temperature. The rotating spherical plasmas 174 and 178 and being compressed into spherical plasma 170 from both sides. The rotating vortices of Device B and Device C are pushing the spherical plasmas 174 and 178 from both sides of spherical plasma 170 into spherical plasma 170.

Referring to FIG. 12c, the top of the induced Larmor gyro orbiting particle field 184, is shown. Also shown is spherical plasma 170, showing the spherical plasma completely surrounded by the encircling, tightening Larmor orbiting particle field.

Referring to FIG. 13, a side view of Device A, Device B and Device C is shown. Device B is perpendicular to horizontal Device A, and is located to the left of Device A. Device C is perpendicular to Device A, and is located to the right of Device A. Device A is horizontal to the Earth. The fusion spherical plasma 170 on top of Device A, is now surrounded by an amorphous mass consisting of spherical plasma 174 and spherical plasma 178. The rotational energy of Device B bottom vortex 34a′ is directed toward spherical plasma 170 as indicated by arrow 194. The rotational energy of Device C bottom vortex 34b′ is directed at spherical plasma 170 as indicated by arrow 196. The The rotational energy and pressure of Device A, bottom vortex 34′ is directed at spherical plasma 170 as indicated by arrow 197, and is also directed against opposing repulsive magnetic North Pole 202 of Device B and repulsive magnetic North Pole 200 of Device C by the repulsive magnetic North Pole 11 of Device A. Remnant organizing rotational force directed toward the fusion spherical plasma 170 from Device B top vortex 34a as represented by arrow 198, and from Device C top vortex 34b, represented by arrow 199, and from Device B on top vortex 34a as represented by arrow 198′, and from Device C top vortex 34b, as represented by arrow 199′. Plasma propulsion 27 can be used to augment lesser rotational force of Device A vortex 34′ as compared to Device B and Device C. Repulsive magnetic North Pole force 202 from top of Device B is directed as indicated by arrow 183, repulsive magnetic north pole force 202 from Device C is directed as indicated by arrow 185. Repulsive magnetic north pole force 202 from Device B is directed as indicated by arrow 68. Repulsive magnetic north pole force 202 from top of Device C is directed as indicated by arrow 69. Repulsive magnetic north pole force 11 from Device A is directed as indicated by arrow 67

The most notable event of all in the on-going fusion process is the absorbtion of the induced Larmor gyro orbiting particle field 182 into the fusion spherical plasma 170. The Larmor orbiting particle field 182 was composed of rotating highly energetic particles increasing in energy to the speed of light. This energy has now been added to the equally energetic rotating particles within the fusion spherical plasma 170. The Incrementally the system, the process is approaching the five billion degree temperature needed for ignition with the fusion fuels Boron-11 Isotope and Regular Hydrogen. Also notabl in FIG. 13, is the absorbtion of the induced electric field 186 FIG. 12a by the fusion spherical plasma 170. Within a short period of time, part of the process, the amorphous mass encircling fusion spherical plasma 170 will also be, essentially, compressed into spherical plasma 170. The amorphous mass, spherical plasma 174 and spherical plasma 178 contains considerable energy. The electric field 186 contains highly energetic particles. The particles are now part of the spherical plasma 170. One additional energy source is to be noted, each of the devices is accompanied by a circular magnetic field around the electric ring of each device. The intersecting rings will concentrate the magnetic flux with consequent increase in temperature, albeit electron volt temperature, primarily.

Referring to FIG. 14, at the moment of ignition of fusion spherical plasma 170, FIG. 12a, there will be an appearance of flames 204, though it is harmless photon radiation, it is not heat. A large quantity of energetic particles are being created. The horizontal Device A, FIG. 12a, will ground itself to high-tension power line 206 by cable 208. The large perpendicular Device B, with an opposing north pole 209 facing north pole 213 of Device C, will ground itself to railroad track 210 by cable 212. Large perpendicular Device C will ground itself to railroad track 214 by cable 216. The three devices, A, B and C are approximately 110 feet above 218 the Earth 76. At the moment of ignition, the smaller Device A, will be moved, as well as move itself, 100 feet in the direction 218 behind the developing plasma cloud. Prior to ignition, the three devices, A, B and C will be close together, almost contiguous. The perpendicular Device C will be blown and move itself 120 feet to the right as represented by arrow 220. The perpendicular Device B, on the left, will be blown and move itself 30 feet to the left as represented by arrow 226.

Referring to FIG. 15, the end phase of the nuclear fusion reaction 228, FIG. 15, is shown. (Though it is not in the same location as the ignition.) Negative ions and particles 230, FIG. 15, attracted to positive charged Earth 76, collect on the bottom of plasma cloud 232. After breakdown of plasma cloud in a failed attempt to organize spherically in the center of plasma cloud 232 and plasma cloud center 230, as indicated by weakly organizing sphere 248, in the center of the plasma cloud 230. The energetic particles slow in their failed attempt to organize into a spherical plasma. The plasma collapses due to insufficient energy to maintain its organizing effort. Negative ions and particles 230, FIG. 15, attracted to positive charged Earth 76, collect on the bottom of plasma cloud 232. On the top of plasma cloud 232, FIG. 15, positive ions and particles 238 collect, having been repelled by assumably positive charged Earth 76.

There is a space between negative and positive charges 240, FIG. 15. The positive charges being repelled by positive Earth, the negative charges being equally attracted by Earth and positive charges above. The approximate width of the cloud is 150 feet a50, FIG. 15. Though technically it is still a plasma cloud, we would now call it a storm cloud, it is composed Of positive and negative ions now. After breakdown of the storm cloud, 230 and 238, FIG. 15, a one and one half foot bolt of green electricity as represented by pointed arrow 244 will strike extended, pointed rod 246, extending out from top of Device B. An equally large bolt of yellow to red electricity will strike pointed rod 236, extending out from Device C. Electricity collected by the two perpendicular devices at each end of the plasma formation, can be transferred to a land-based superconducting ring at a power distribution center by microwave transmission, or by direct transfer of electricity due to close proximity to fusion reaction. The side width of this plasma formation, now collapsed, was approximately 40 feet. The height of plasma formation above ground 254, FIG. 15, was approximately 70 or 80 feet as shown in FIG. 15. The North Pole 11 of both perpendicular devices is shown. Ground cable 256 from Device C on right, connected to railroad track 258. A remote magnetic release disengaged ground cable connection 254b. Ground cable 260 from Device B on left, connected to railroad track 262. A remote magnetic release 254a disengaged ground cable 260. The horizontal Device A has been located behind the opaque plasma cloud, approximately 100 feet from ignition location, with no ostensible connection to end phase of nuclear fusion reaction process. When the aircraft need additional energy, the energy will come from the capacitance-inductance system. When the energy is no longer needed, it will be returned to the capacitance-inductance system of the aircraft.

Referring to FIG. 1, the aircraft will possess diagnostics for determining plasma equilibria on a Engineer Control Panel on the top deck. Instruments and gauges for pilot control will resemble those of conventional aircraft, to include the most advanced flight control systems.

1-20. (canceled)

21. A multi-functional aircraft comprising: a body hull, a plurality of blades arrayed around said aircraft, said blades mounted to be pivotally moveable, each of said blades capable of independent pivotal movement, said blades also being called ailerons, a plurality of capacitors, an interconnecting electric system, an induction coil, a vertical central shaft, said induction coil extending within said central shaft, from top to bottom, said central shaft extending through vertical center of said aircraft from top to bottom of said aircraft, a second plurality of capacitors arrayed around said central shaft, a means for propulsion of said aircraft, a means for landing, said blades being conducting and used for navigation of said aircraft, said vertical extending induction coil forming an oscillatory circuit in conjunction with said capacitors.

22. The aircraft as defined in claim 21 wherein said propulsion means includes propulsion by use of rotating plasma vortices with motional direction of rotation being generally up away from the earth, or in the direction as positioned by said ailerons.

23. The aircraft as defined in claim 21 wherein said propulsion will be by means of said capacitors used as electrodes in a manner first proposed by Dr. T. Townsend Brown, he, however, not having a system that effectively neutralized gravity, which is herein accomplished.

24. The aircraft as defined in claim 21 wherein said propulsion will be by means of plasma propulsion with a radial electric current and plasma current in combination with an existant Lorentz force, said aircraft will be propelled with extreme speed in conjunction with a pulsed current, also in submersible craft.

25. The aircraft as defined in claim 21 wherein said propulsion will be by means of the craft's high electric field interacting with the Earth's magnetic field at a ninety degree angle.

26. The aircraft as defined in claim 21 wherein said means for landing will include a flat landing surface on bottom of said aircraft.

27. An aircraft possessing the means for a process, or method, to produce Larmor gyro orbiting particle fields around said aircraft, said method comprising the steps of utilizing water as fuel, said solution of water being contained in vessels within said aircraft, said water is next decomposed by electrolysis, said produced energetic ions are then transported by a means of conveyance to Larmor gyro orbits around said aircraft, whereby said aircraft will be enabled to rise off the earth, in fact, into outer space if desired, said propulsion in outer space will be accomplished by particle propulsion utilizing said capacitors as storage vessals for plasma stored within capacitor plates, and utilizing said capacitor plates as electrodes for particle propulsion in space, said Larmor orbiting particle fields will form on the top of the bladed ring assembly, and on the bottom of said blade assembly, within the atmosphere, said funnel shaped vortices increase in energy to the speed of light, said energy being generally considered to come from the magnetic field, by controlling the capacitance and inductance systems, the plasma fields can be controlled, energy can be increased, the length of vortices will increase with increased energy, speed of aircraft will increase proportionally.

28. The aircraft as defined in claim 27, wherein said vessels will be drum barrel shaped.

29. The aircraft as defined in claim 27 wherein said electrolysis will be by means of Electrodes.

30. The aircraft as defined in claim 27 wherein said means of conveyance will be by means of tubes.

31. The aircraft as defined in claim 27 wherein said means of conveyance will include an upper portion of said tubes whereby said ions can be accelerated by means of a ferromagnetic core within center of said tube, required in fusion procedures.

32. The aircraft as defined in claim 27 wherein by utilizing said Larmor orbiting particle fields, said aircraft will be able to navigate said aircraft with said particle impacts and repulsive force on said conducting ailerons within said particle fields.

33. An aircraft in combination with two or more similar but larer aircraft, said larger aircraft being comprised of differing material, in other aspects being identical to smaller aircraft, said three aircraft comprising the means for a process for obtaining energy from a fusion spherical plasma formed on the roof of said smaller aircraft, by a method comprising positioning said larger aircraft perpendicular to horizontal smaller craft relative to earth, and by raising a pyramidal shaped cone on the roof of said smaller craft, an induced magnetic field is formed, an induced electric field is formed around said spherical fusion plasma, and an induced Larmor partical field is formed around said fusion spherical plasma, non-fusion spherical plasmas having formed on roofs of larger craft, by means of increasing rotation of bottom vortices of said larger aircraft, requisite pressure and temperature are applied upon fusion spherical plasma, in addition to pressure applied from increasingly tightening Larmor induced particle field, said spherical plasmas on roofs of larger craft have been forced into fusion spherical plasma as have the induced Larmor particle field, the induced electric current, with thermal energy from the magnetic flux of three interpenetrating magnetic fields around annular rings of said three aircraft,
additional pressure from smaller craft is provided by plasma propulsion and bottom rotating vortex of said smaller aircraft, said induced Larmor partical field, induced electric current and spherical plasmas Of the three aircraft, being comprised of energetic charged particles, these particles having been added to energy of fusion spherical plasma, conditions are opportune for ignition, if required a land based high power X-ray, or land based neutral beam can effect ignition, whereby energy, in the form of electricity, is produced, said electricity attemps to organize into a huge spherical plasma between the two larger, now separated aircraft, a distance near 150 feet. failure to organize leads to collapse of huge organizing mass, said electric bolts being captured by two larger craft by means of extended rods.

34. The aircraft fusion process as defined in claim 33, wherein said fusion fuels will be comprised of Boron B-11 isotope and Regular Hydrogen, H-1 atoms.

35. The aircraft fusion process as defined in claim 33, wherein said larger aircraft are comprised of magnesium material.

36. The aircraft fusion process as defined in claim 33, wherein said B-11 isotope fuel will be conveyed from a separate barrel within smaller aircraft.

37. The aircraft fusion process as defined in claim 33, wherein said B-11 isotope will be vaporized out of source.

38. The aircraft fusion process as defined in claim 33, wherein said B-11 isotope ions will be contained within a barrel shaped container under pressure within smaller aircraft.

39. The aircraft fusion process as defined in claim 33, wherein said fusion spherical plasma in smaller aircraft, and spherical plasmas in larger aircraft are formed within an oscillating inhomogeneous plasma field.

40. The aircraft fusion process as defined in claim 33, wherein said fusion fuels will be placed in mini-larmor orbits forming into plasma spherules prior to forming into fusion spherical plasma by means of rotation around upper portion of said conveyance tubes, said upper portion containing a ferromagnetic core within said conveyance tube.
